(19) United States
(12) Patent Application Publication
(10) Pub. No.: US 2017/0146843 A1
(43) Pub. Date: May 25, 2017

(54) LIQUID CRYSTAL DISPLAY PANEL AND LIQUID CRYSTAL DISPLAY DEVICE

(71) Applicants: Shenzhen China Star Optoelectronics Technology Co., Ltd., Guangdong (CN); Wuhan China Star Optoelectronics Technology Co., Ltd., Wuhan, Hubei (CN)

(72) Inventor: Yuejun TANG, Guangdong (CN)

(21) Appl. No.: 14/776,278

(22) PCT Filed: Aug. 14, 2015
(86) PCT No.: PCT/CN2015/086997

§ 371 Date: Sep. 14, 2015

(30) Foreign Application Priority Data
Apr. 29, 2015 (CN) 201510213888.1

(51) Int. Cl. G02F 1/1339; G02F 1/1335

(52) U.S. Cl. CPC G02F 1/13394; G02F 1/133512; G02F 1/133514; G02F 2001/13396; G02F 2001/13398

(57) ABSTRACT

A liquid crystal display panel, which includes a first substrate and a second substrate disposed opposite to each other, a black matrix and a color filter layer sequentially formed on the first substrate, a main photo spacer formed on the color filter layer and contacting the second substrate, wherein the main photo spacer is positioned below the black matrix, and a width of a part of the main photo spacer formed on the color filter layer is larger than a width of a part of the main photo spacer contacting the second substrate, and the part of the main photo spacer contacting the second substrate contacts the second substrate through a receiving portion on the second substrate. A liquid crystal display device having the liquid crystal display panel is also disclosed.

### TECHNICAL FIELD

The present disclosure relates to a technical field of a liquid crystal display, and particularly, to a liquid crystal display panel and a liquid crystal display device.

### BACKGROUND ART

With evolution of photoelectricity and semiconductor technologies, a vigorous development of a flat panel display has been driven, and among various kinds of flat panel displays, e a liquid crystal display (LCD) has become a market mainstream because of having lots of advantageous properties, such as high utilization efficiency of space, low power consumption, no radiation and low electromagnetic interference, etc.

FIG. 1 is a structural schematic view of a liquid crystal display device of the prior art. Referring to FIG. 1, a liquid crystal display device 1 generally comprises a backlight module 2 and a liquid crystal display panel 3 disposed opposite to the backlight module 2. Since the liquid crystal display panel 3 cannot emit light itself, it needs the backlight module 2 to provide a display light source. The liquid crystal display panel 3 displays an image via the display light source provided by the backlight module 2.

The liquid crystal display panel 3 generally comprises a thin film transistor (TFT) array substrate 31 and a color filter (CF) substrate 32 disposed opposite to each other for cells, and a liquid crystal layer 33 disposed therebetween. In order to support and maintain an interval between the TFT substrate 31 and the CF substrate 32, a plurality of main photo spacers 321 contacting the TFT substrate 31 and a plurality of sub photo spacers 322 not contacting the TFT substrate 31, wherein the main photo spacers 321 has a distribution density lower than that of the sub photo spacers 322.

When the liquid crystal display panel 3 receives a uniform pressure with a large area, the main photo spacers 321 are compressed to have the same height as the sub photo spacers 322, and at this time, the sub photo spacers 322 with the high density begins to share the received pressure, whereas when the liquid crystal display panel 3 receives a nonuniform pressure, especially a nonuniform pressure against some point on the liquid crystal display panel 3 (for example, a nonuniform pressure generated during a grind process and a dynamic pressure test after thinning), a single main photo spacer 321 may receive an excessive pressure, causing the main photo spacer 321 to be damaged due to highly compressing. In addition, when the liquid crystal display panel 3 receives a lateral push pressure, the TFT substrate 31 and the CF substrate 32 are extremely easy to be misplaced, thereby resulting in leakage of light.

### SUMMARY

In order to solve the above problem existing in the prior art, the present disclosure provides a liquid crystal display panel, which comprises: a first substrate, a second substrate disposed opposite to the first substrate, a black matrix formed on the first substrate, a color filter layer formed on the black matrix, a main photo spacer formed on the color filter layer and contacting the second substrate, wherein the main photo spacer is positioned below the black matrix, and a width of a part of the main photo spacer formed on the color filter layer is larger than a width of a part of the main photo spacer contacting the second substrate, and wherein the second substrate has a receiving portion corresponding to the main photo spacer, and the part of the main photo spacer contacting the second substrate contacts the second substrate through the receiving portion.

Further, the width of the part of the main photo spacer formed on the color filter layer is larger than a width of the receiving portion.

Further, the receiving portion is a groove formed on the second substrate.

Further, the liquid crystal display panel further comprises a first bump and a second bump separately formed on the second substrate with intervals, and the receiving portion is formed between the first bump and the second bump.

Further, heights of the first bump and the second bump are the same.

Further, the liquid crystal display panel further comprises sub photo spacers formed to be spaced apart from the main photo spacer on the color filter layer, wherein the sub photo spacers are located below the black matrix, and do not contact the second substrate.

Further, the liquid crystal display panel further comprises third bumps formed on the second substrate corresponding to the sub photo spacers.

Further, heights of the first bump, the second bump and the third bump are the same.

The present disclosure provides a liquid crystal display device, which comprises a backlight module and a liquid crystal display panel described as above disposed opposite to the backlight module, the liquid crystal display panel being provided with providing a display light source from the backlight module to display an image.

The liquid crystal display panel and the liquid crystal display device of the present disclosure may avoid the main photo spacer from being damaged due to being excessively compressed when the liquid crystal display panel receives a pressure. Moreover, the liquid crystal display panel may avoid the first substrate and the second substrate from being misplaced so as to prevent leakage of light occurring in the liquid crystal display panel when the liquid crystal display panel receives a lateral pressure.

### BRIEF DESCRIPTION OF THE DRAWINGS

The above and other aspects, features and advantages of embodiments in the present disclosure will become more apparent from the following description, taken in conjunction with the accompanying drawings in which:

FIG. 1 is a structural schematic view of a liquid crystal display device of the prior art;

FIG. 2 is a side view of a liquid crystal display panel according to an embodiment of the present disclosure;

FIG. 3 is a state view of the liquid crystal display panel illustrated in FIG. 2 receiving a positive pressure;

FIG. 4 is a state view of the liquid crystal display panel illustrated in FIG. 2 receiving a diagonal pressure;

FIG. 5 is a side view of a liquid crystal display panel according to another embodiment of the present disclosure;

FIG. 6 is a state view of the liquid crystal display panel illustrated in FIG. 5 receiving a positive pressure;

FIG. 7 is a state view of the liquid crystal display panel illustrated in FIG. 5 receiving a diagonal pressure; and

FIG. 8 is a structural schematic view of a liquid crystal display device according to an embodiment of the present disclosure.

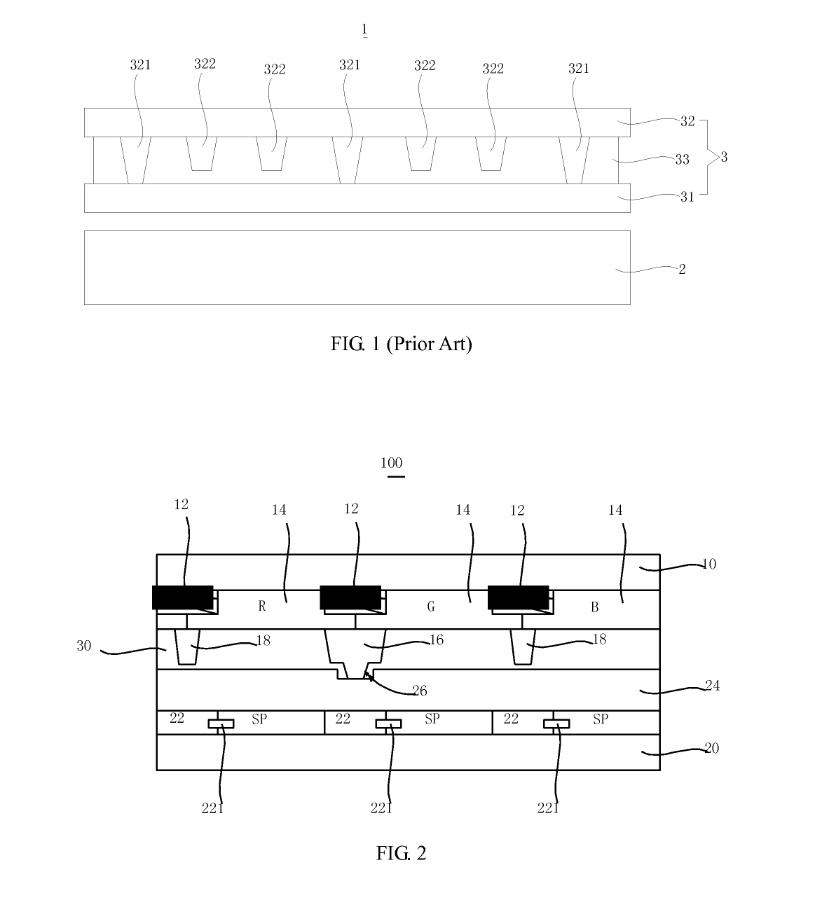

### DETAILED DESCRIPTION OF EXEMPLARY EMBODIMENTS

Embodiments of the present disclosure will be described in detail below by referring to the accompany drawings. However, the present disclosure can be implemented in many different forms, and should not be construed to be limited to the specific embodiments set forth herein. Rather, these embodiments are provided for explaining the principle and actual application of the present disclosure, such that those skilled in the art can understand various embodiments and various modifications suitable for specific expected applications of the present disclosure. In the drawings, for the sake of clarity, thicknesses of layers and areas are exaggerated, and like reference numerals can be used to indicate identical element throughout the specification and drawings. It will be further understood that when a layer or an element is referred to as being formed “on” another layer or substrate, it can be directly formed on the other layer or substrate, or intermediate layers may also exist can also be present.

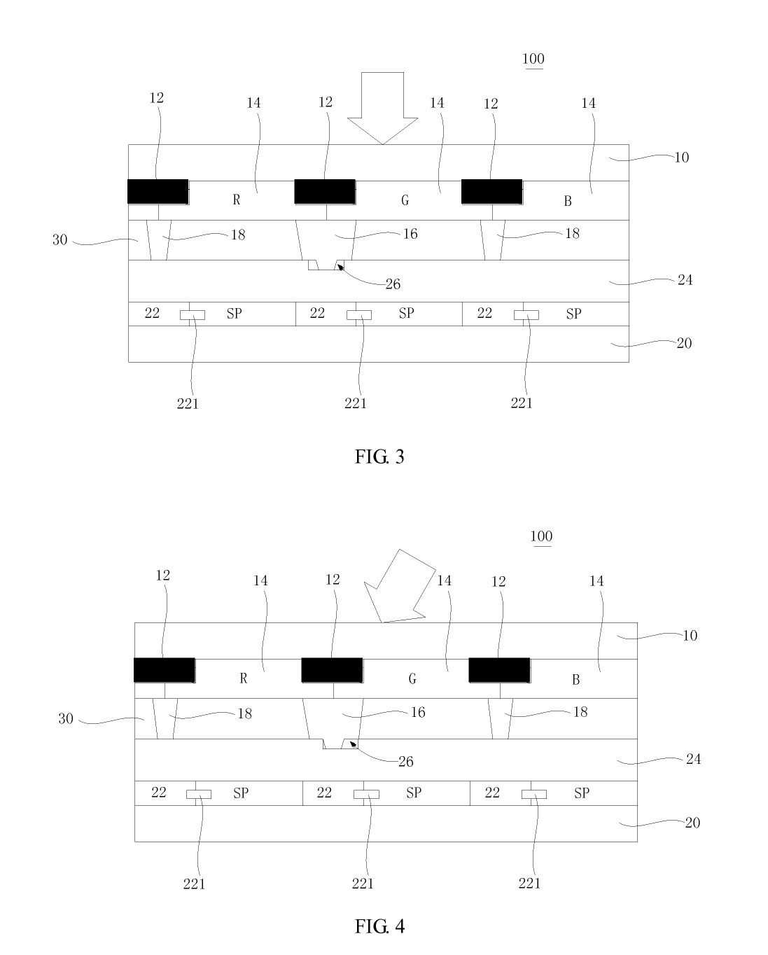

FIG. 2 is a side view of a liquid crystal display panel according to an embodiment of the present disclosure. FIG. 3 is a state view of the liquid crystal display panel illustrated in FIG. 2 receiving a positive pressure. FIG. 4 is a state view of the liquid crystal display panel illustrated in FIG. 2 receiving a diagonal pressure.

Referring to FIG. 2, a liquid crystal display panel 100 according to an embodiment of the present disclosure at least comprises a first substrate 10 and a second substrate 20 opposite to each other for cells, and a liquid crystal layer 30 disposed between the first substrate 10 and the second substrate 20 and containing a plurality of liquid crystal molecules.

The second substrate 20 has a display region comprising a plurality of sub-pixel regions SP, and has a plurality of switching transistors (for example, thin film transistors) 22 disposed thereon, each of which has a pixel electrode 221 disposed in one of the sub-pixel regions SP correspond thereto. A planarization layer 24 completely covering all of the switch transistors 22 and all of the sub-pixel regions SP thereunder is further disposed on the second substrate 20. It should be understood that a common electrode, a pixel electrode and other suitable types of structures are further formed on the planarization layer 24 according to the embodiment of the present disclosure. Receiving portions 26 disposed on the planarization layer 24 will be described in detail below.

Black matrices 12, a color filter layer 14 and main photo spacers (MPSs) 16 are at least disposed on the first substrate 1. It should be explained that other suitable types of elements can be further disposed on the first substrate 10 according to difference in modes of liquid crystal display panels. The number of the main photo spacers 16 is not limited as illustrated in the drawing, and can be arbitrarily disposed according to requirements.

The black matrices (BM) 12, which may be made of a black resin or metal chrome, are formed on the first substrate 10. The switch transistors 22 formed on the second substrate 20 are directly opposite to the black matrices 12. The color filter layer 14 comprising a red color blocking layer (R), a green color blocking layer (G) and a blue color blocking layer (B) which are sequentially formed is formed on the first substrate 10 and covers the black matrices 12.

The main photo spacers 16 are separately formed on the color filter layer 14, and separately formed below the black matrices 12. The receiving portions 26 on the second substrate 20 correspond to the main photo spacers 16 one by one, and the main photo spacers 16 contact the second substrate 20 through respective receiving portions 26, and thus can maintain a space between the first substrate 10 and the second substrate 20. A width of a part of each of the main photo spacers 16 which is formed on the color filter layer 14 is larger than a width of a part thereof contacting the second substrate 20, and the specific advantageous effects will be described below.

Preferably, in embodiments of the present disclosure, a width of a part of each main photo spacer 16 formed on the color filter layer 14 is larger than a width of the receiving portion 26, and specific advantageous effects will be described below.

In embodiments of the present disclosure, the receiving portions 26 may be, for example, grooves formed in the planarization layer 24. The main photo spacers 16 are accommodated in the grooves 26, thereby contacting the second substrate 20.

In addition, sub photo spacers (SPSs) 18 are further disposed on the first substrate 10. The sub photo spacers 18 are formed to be spaced apart from the main photo spacers 16 on the color filter layer 14, which are also disposed below the black matrices 12. The sub photo spacers 18 do not contact with the second substrate 20 when the first substrate 10 and the second substrate 20 are disposed opposite to each other for cells. The number of the sub photo spacers 18 is not limited as illustrated in the drawing, and may be arbitrarily set according to requirements.

Referring to FIG. 3, when the liquid crystal display panel 100 according to the embodiment of the present disclosure receives a positive pressure (indicated by a positive arrow downward in the drawing), the main photo spacers 16 are compressed. Since a width of a part of the main photo spacer 16 formed on the color filter layer 14 is larger than a width of the groove 26, the part of the main photo spacer 16 formed on the color filter layer 14 can be compressed against the non-groove on the second substrate 20 in time, and since a width of a part of the main photo spacer 16 formed on the color filter layer 14 is larger than a width of a part thereof contacting the second substrate 20 with a relatively larger area being compressed, it is not easy to be damaged due to being excessively compressed.

Referring to FIG. 4, when the liquid crystal display panel 100 according to the embodiment of the present disclosure receives a lateral pressure (indicated by a inclinedly downward arrow in the drawing), since a width of a part of the main photo spacer 16 formed on the color filter layer 14 is larger than a width of a part thereof contacting the second substrate 20, a width difference is formed therebetween to allow the main photo spacer 16 to be chucked into the groove 26, thereby avoiding the first substrate 10 and the second substrate 20 from being misplaced, and further preventing leakage of light occurring in the liquid crystal display panel 100.

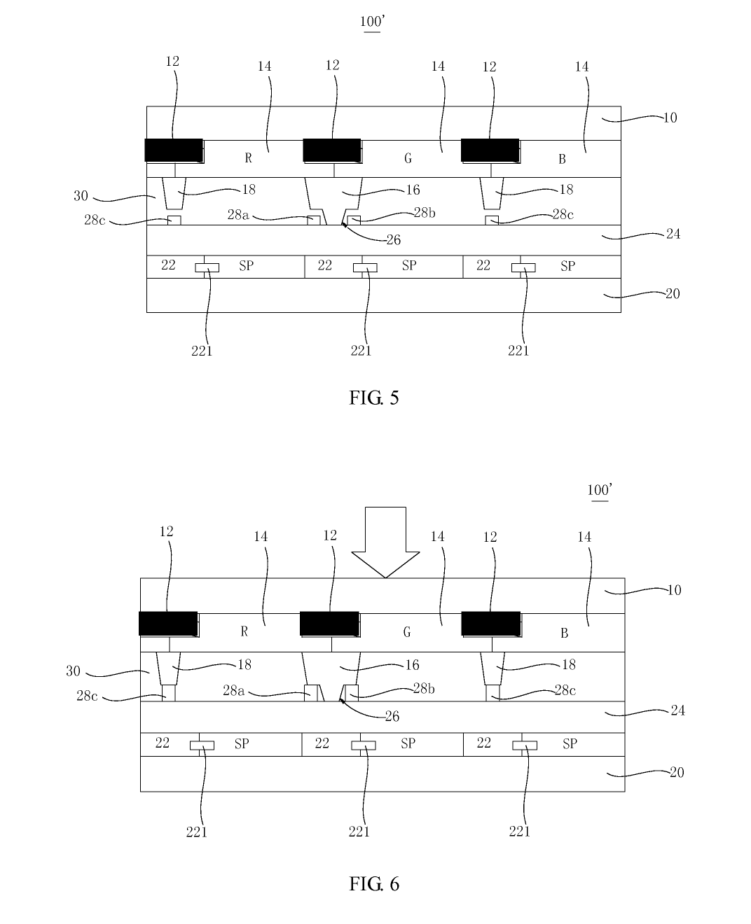

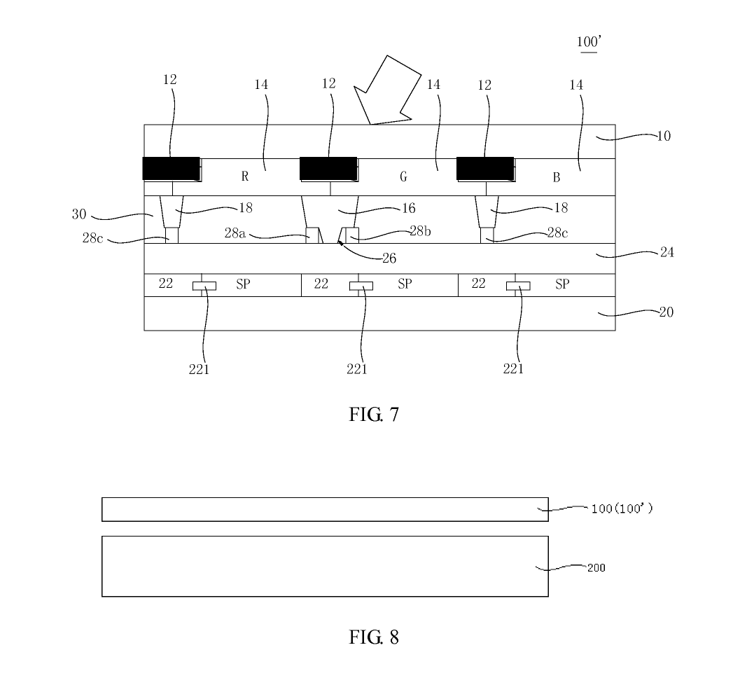

FIG. 5 is a side view of a liquid crystal display panel according to another embodiment of the present disclosure. FIG. 6 is a state view of the liquid crystal display panel illustrated in FIG. 5 receiving a positive pressure. FIG. 7 is a state view of the liquid crystal display panel illustrated in FIG. 5 receiving a diagonal pressure.

Referring to FIG. 5, the liquid crystal display panel 100′ illustrated therein differs from the liquid crystal display panel 100 illustrated in FIG. 2 in that a first bump 28a and a second bump 28b are further separately formed on the second substrate 20, wherein the receiving portion 26 is formed between the first bump 28a and the second bump 28b. Preferably, the first bump 28a and the second bump 28b have the same height.

In addition, third bumps 28c are further formed on the second substrate 20 in one-to-one correspondence to the sub photo spacers 18. When the liquid crystal display panel 100′ receives a pressure, the third bumps 28c contact the sub photo spacers 18.

Referring to FIG. 6, when the liquid crystal display panel 100′ according to the embodiment of the present disclosure receives a positive pressure (indicated by a positive arrow downward used in the drawing), the main photo spacer 16 is compressed. Since a width of a part of the main photo spacer 16 formed on the color filter layer 14 is larger than a distance between the first bump 28a and the second bump 28b, the part of the main photo spacer 16 formed on the color filter layer 14 can be compressed against the first bump 28a and the second bump 28b in time, and since a width of a part of the main photo spacer 16 formed on the color filter layer 14 is larger than a width of a part thereof contacting the second substrate 20 with a relatively large compressed area, it is not easy to be damaged due to being excessively compressed.

Referring to FIG. 7, when the liquid crystal display panel 100 according to the embodiment of the present disclosure receives a lateral pressure (indicated by a inclinedly downward arrow in the drawing), since a width of a part of the main photo spacer 16 formed on the color filter layer 14 is larger than a width of a part thereof contacting the second substrate 20, a width difference is formed therebetween to allow the main photo spacer 16 to be chucked between the first bump 28a and the second bump 28b, thereby avoiding the first substrate 10 and the second substrate 20 from being misplaced, and further preventing leakage of light occurring in the liquid crystal display panel 100.

FIG. 8 is a structural schematic view of a liquid crystal display device according to an embodiment of the present disclosure.

Referring to FIG. 8, a liquid crystal display device according to an embodiment of the present disclosure comprises a backlight module 200 and the liquid crystal display panel 100 or 100′ illustrated in FIG. 2 or 5 disposed opposite to the backlight module 200. Since the liquid crystal display panel 100 or 100′ illustrated in FIG. 2 or 5 cannot emit light itself, it needs the backlight module 200 to provide a display light source. The liquid crystal display panel 100 or 100′ illustrated in FIG. 2 or 5 displays an image via the display light source provided by the backlight module 200.

Although the present disclosure is shown and described with reference to certain embodiments, it will be understood by those skilled in the art that various changes in form and details can be made herein without departing from the spirit and scope of the disclosure as defined by the appended claims and equivalents thereof.

What is claimed is:

1. A liquid crystal display panel, comprising:
a first substrate;
a second substrate disposed opposite to the first substrate;
a black matrix formed on the first substrate;
a color filter layer formed on the black matrix; and
a main photo spacer formed on the color filter layer and contacting the second substrate, wherein the main photo spacer is positioned below the black matrix, and a width of a part of the main photo spacer formed on the color filter layer is larger than a width of a part of the main photo spacer contacting the second substrate,
wherein the second substrate has a receiving portion corresponding to the main photo spacer, and the part of the main photo spacer contacting the second substrate contacts the second substrate through the receiving portion.

2. The liquid crystal display panel of claim 1, wherein the width of the part of the main photo spacer formed on the color filter layer is larger than a width of the receiving portion.

3. The liquid crystal display panel of claim 1, wherein the receiving portion is a groove formed on the second substrate.

4. The liquid crystal display panel of claim 1, further comprising a first bump and a second bump separately formed on the second substrate, and the receiving portion is formed between the first bump and the second bump.

5. The liquid crystal display panel of claim 4, wherein the first bump has a same height as the second bump.

6. The liquid crystal display panel of claim 3, further comprising sub photo spacers formed to be spaced apart from the main photo spacer on the color filter layer, wherein the sub photo spacers are located below the black matrix and do not contact the second substrate.

7. The liquid crystal display panel of claim 5, further comprising sub photo spacers formed to be spaced apart from the main photo spacer on the color filter layer, wherein the sub photo spacers are located below the black matrix, and do not contact the second substrate.

8. The liquid crystal display panel of claim 7, further comprising third bumps formed on the second substrate, the third bumps corresponding to the sub photo spacers.

9. The liquid crystal display panel of claim 8, wherein heights of the first bump, the second bump and the third bumps are identical.

10. A liquid crystal display device, comprising a backlight module and a liquid crystal display panel disposed opposite to the backlight module, the liquid crystal display panel being provided with providing a display light source from the backlight module to display an image, the liquid crystal display panel comprising:
a first substrate;
a second substrate disposed opposite to the first substrate;
a black matrix formed on the first substrate;
a color filter layer formed on the black matrix; and
a main photo spacer formed on the color filter layer and contacting the second substrate, wherein the main photo spacer is positioned below the black matrix, and a width of a part of the main photo spacer formed on the color filter layer is larger than a width of a part of the main photo spacer contacting the second substrate;
wherein the second substrate has a receiving portion corresponding to the main photo spacer, and the part of the main photo spacer contacting the second substrate contacts the second substrate through the receiving portion.

11. The liquid crystal display device of claim 10, wherein the width of the part of the main photo spacer formed on the color filter layer is larger than a width of the receiving portion.

12. The liquid crystal display device of claim 10, wherein the receiving portion is a groove formed on the second substrate.

13. The liquid crystal display device of claim 10, wherein the liquid crystal display panel further comprises a first bump and a second bump separately formed on the second substrate, and the receiving portion is formed between the first bump and the second bump.

14. The liquid crystal display device of claim 13, wherein the first bump has a same height as the second bump.

15. The liquid crystal display device of claim 12, wherein the liquid crystal display panel further comprises sub photo spacers formed to be spaced apart from the main photo spacer on the color filter layer, wherein the sub photo spacers are located below the black matrix, and do not contact the second substrate.

16. The liquid crystal display device of claim 14, wherein the liquid crystal display panel further comprises sub photo spacers formed to be spaced apart from the main photo spacer on the color filter layer, wherein the sub photo spacers are located below the black matrix, and do not contact the second substrate.

17. The liquid crystal display device of claim 16, wherein the liquid crystal display panel further comprises third bumps formed on the second substrate, and the third bumps correspond to the sub photo spacers.

18. The liquid crystal display panel of claim 17, wherein the first bump, the second bump and the third bump have a same height.
